(19) United States
(12) Patent Application Publication
(10) Pub. No.: US 2004/0136880 A1
(43) Pub. Date: Jul. 15, 2004

(54) Smoke-emitting decorative article

(75) Inventors: Uta Feldevert, Gronau (DE); Peter Krellner, Olbernhau (DE)

Correspondence Address: JORDAN AND HAMBURG LLP, 122 EAST 42ND STREET, SUITE 4000, NEW YORK, NY, 10168, US

(73) Assignee: KWO Kunstgewerbe-Werkstaetten GmbH, Olbernhau (DE)

(21) Appl. No.: 10/744,400

(22) Filed: Dec. 23, 2003

(30) Foreign Application Priority Data
Dec. 23, 2002 (DE) 202 20 084.1

(51) Int. Cl. B32B 5/02; A62B 7/08

(52) U.S. Cl. 422/126; 422/123; 422/120

(57) ABSTRACT

This invention relates to smoke-emitting decorative articles in which incense cones are situated in a hollow space on a placement surface, a first section of a smoke gas channel is arranged at the end of the hollow space so that it rises steeply, a second section of a smoke gas channel with a lower slope being arranged at the end of the first section and the combustion gases formed by burning of the incense cone being discharged through the smoke gas channel.

### 1. SCOPE OF THE INVENTION

This invention is used for decorative articles which emit smoke when used as intended, mainly for Erz Mountain incense-burning figurines which can be equipped with incense cones.

### 2. STATE OF THE ART

Erz Mountain incense-burning figurines are known in which an incense-burning chamber is formed in the interior of a figure or other object that can be divided. A cone of incense burning in this chamber producing a large quantity of smoke which is then vented to the outside through an outgoing smoke gas channel. Such figurines are usually designed according to natural models and have a smoke gas channel that either leads vertically upward or is continued horizontally after a right angle bend and escapes to the outside through a mouth hole in the figure.

According to German Utility Model DE 296 03 118 U1, a one-piece straight smoke gas channel diverts the smoke gases as they rise out of the burning chamber. In addition, it is also proposed that a diffuser be provided at the point of outlet, so that the smoke escaping is distributed over a large area opening (coffee cup).

German Utility Model DE 201 12 580 U1 proposes that a portion of the smoke gas be diverted from the total stream in the burning chamber and guided to the outside through a second smoke gas channel which may also lead downward.

The known embodiment of Erz Mountain incense-burning figurines results in a largely static design of the figurines which can be relieved somewhat only through an appropriate external design.

The proposal according to German Utility Model DE 296 03 118 U1 is limited to a few embodiments of incense-burning figurines—likewise according to German Utility Model DE 201 12 580 U1, which also necessitates a precisely coordinated design of the burning chamber and the smoke gas channels because otherwise the draft which is necessary for uniform burning of the incense cones cannot be ensured.

The object of this invention is to propose embodiments of smoke gas channels in incense-burning figurines which on the basis of their technical features permit a variety of embodiments of incense-burning figurines, ensure uniform burn-up of the incense-burning cones and at the same time open up new design possibilities for the figurines.

### NATURE OF THE INVENTION

The nature of this invention is derived from the features disclosed in the patent claims which are explained in greater detail in the description. The drawings and the exemplary embodiments give preferred embodiments of this invention at the time of filing of this invention.

According to this invention, in a decorative article which emits smoke from an incense cone in its interior when used as intended, the smoke produced is passed through a specially shaped smoke gas channel over a long distance and is set free at the end of the smoke gas channel at least through one opening. In doing so, a large structural part is designed at first in the traditional way, forming the burning chamber and resting with its lower edge on a base. The base has in a known way a placement and/or holding element on which incense cones can be situated. The external shape and material of the structural part as well as the base can be selected as desired. A borehole is provided in the area of the upper end or the side faces of the structural part. The axis of the borehole introduced into the figure does not run vertically.

A sleeve-shaped structural part is inserted into the borehole, this structural part in turn having a concentric borehole. The sleeve-shaped structural part is designed at least with a form-fitting shape in the contact area with the borehole in the structural part. It may also be shaped according to design aspects or properties of the material selected.

The sleeve-shaped structural part forms a first section of the smoke gas channel. The sleeve-shaped structural part together with the burning chamber forms a smoke gas channel which is longer than is the case with conventional incense-burning figurines. At the same time, this ensures a good draft in the smoke gas channel.

At the upper end of the first section of the smoke gas channel, at least one additional structural part is connected to same, forming a second section of the smoke gas channel.

The second section of the smoke gas channel does not run at the same angle as the first section. It may also have multiple bends, may be provided with different diameters or may not be designed to run in a straight line.

A preferred embodiment of this invention uses a borehole with a larger diameter which is introduced into the structural part surrounding the burning chamber and into which the sleeve-shaped structural part forming the first section of the smoke gas channel is then inserted with the two structural parts then being joined together. An extra structural part is arranged at the upper end of the sleeve-shaped structural part, the change in angle between the first and second sections of the smoke gas channel being accomplished with the help of this additional structural part. At least one other structural part then forms the second section of the smoke gas channel.

The additional structural part may serve as a head of a model simulation of humans or animals, for example, given an appropriate design of the decorative object. Likewise, there is the possibility of designing this structural part as a model simulation of a technical structural part.

The structural part forming the base body may be designed, depending on requirements, so that its central axis, which is also the central axis of the burning chamber, is arranged vertically or at any other desired angle in the space while the first section of the smoke gas channel runs at another angle to the central axis. If the sleeve-shaped structural part protrudes out of the base body, its outer jacket may be included in the design of the three-dimensional shape of the decorative article.

The structural part forming the second section of the smoke gas channel is largely implementable according to the requirements of its use. Thus a single structural part may form this section, with a smoke outlet opening being provided at the end of the structural part. It is likewise possible to keep the end of this structural part closed, in which case the smoke will escape through several openings arranged axially with an offset or openings introduced laterally.

A preferred embodiment here is the arrangement of a structural part with a basic borehole which then receives a lateral opening through at least one peripheral borehole. In this case, an embodiment of this invention is again preferred using two peripheral boreholes which at the same time are also supplemented by structural parts which serve primarily design purposes and form, for example, the shape of a nose and/or a mouth.

Another embodiment of this invention has a second section of the smoke gas channel consisting of a plurality of structural parts. A first structural part is connected to the sleeve-shaped structural part or another intermediate structural part that is also present. It is designed in the form of a sleeve or a ring. Then at least one other structural part which may in turn be designed in the form of a sleeve or ring, is situated in this extension.

The connections between the structural parts may be accomplished by simple fastening with adhesive at the end faces which come in contact. However, it is also equally possible to design the structural parts that are used with an integrally molded collar on their end faces, to insert intermediate sleeves or to introduce a supporting structure into the borehole. In addition, connecting elements may also be used.

It is particularly advantageous to use sleeve-shaped or ring-shaped structural parts with end faces that are not in parallel. This makes is possible to achieve a curved path of the second section of the smoke gas channel.

It is likewise possible to provide sleeves or ring-shaped structural parts with integrally molded collars on one or both sides so that it is possible to center adjacent structural parts. The structural part to be paired has a suitably shaped recess in the area of the collar. At the same time, the contact surface between the structural parts is thus increased and so the stability of any adhesive joints created is also improved.

Another embodiment of this invention consists of the fact that the sleeves or ring-shaped structural parts each have a convex curvature on one end face and the opposing end face has a concave curvature. At the same time this achieves an enlarged contact area between the structural parts. Furthermore the structural parts to be paired may also be arranged with a lateral shift and thus the desired path of the respective section of the smoke gas channel can be achieved.

Another embodiment is obtained when a supporting structure in the form of a cage or a sleeve is created in the interior of the smoke gas channel and structural parts forming the smoke gas channel are then pushed onto it. If necessary, a second section which also runs in a straight line to some extent and runs with a curve in another area may also be provided.

The embodiment of the second section of the smoke gas channel which has a curvature may also be used with the first section thereof when so required.

According to the design conventionally used with Erz Mountain incense-burning figurines, the embodiment described here can be supplemented with additional elements which serve only a design purpose. For example, the connecting structural part between two sections of the smoke gas channel may preferably be designed as a head. In addition, the arrangement may also be positioned on a base plate and supplemented with arms and legs.

Due to the nonvertical arrangement of the first section of the smoke gas channel, this results in the possibility of designing incense-burning figurines in dynamic postures and developing design options that could not be used in the past.

A particularly advantageous embodiment is obtained when the base plate also forms the bottom of the figure and additional structural parts such as arms are arranged on the periphery of the base plate or on the body. This permits an embodiment of an incense-burning figure that is sitting down and may be designed, for example, with the legs crossed or with the legs hanging over an edge. The center of gravity of such figurines makes it possible for them to be set up at the edge of a housing without endangering the stability of such figurines.

### EXEMPLARY EMBODIMENTS

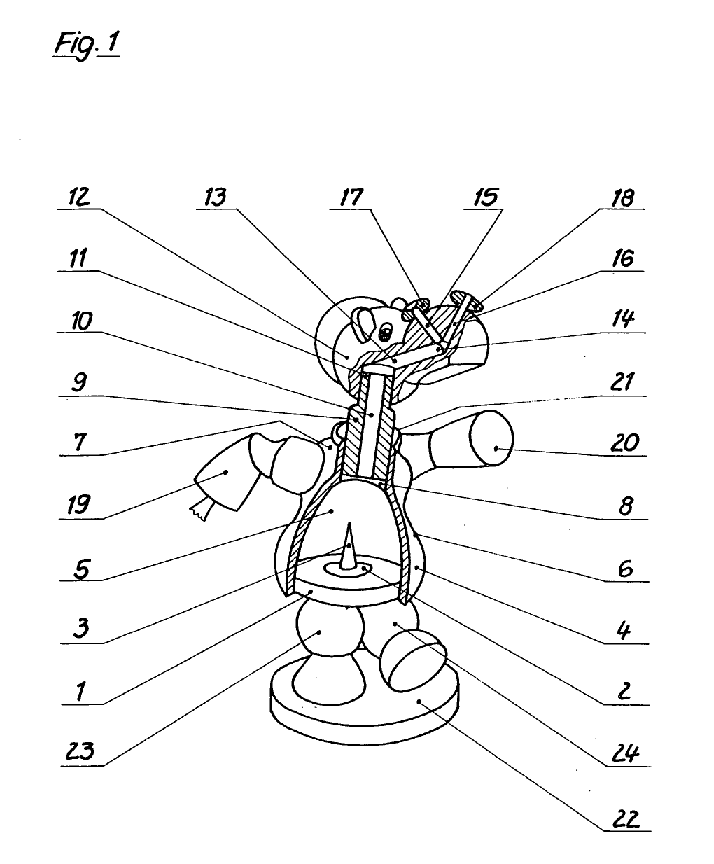

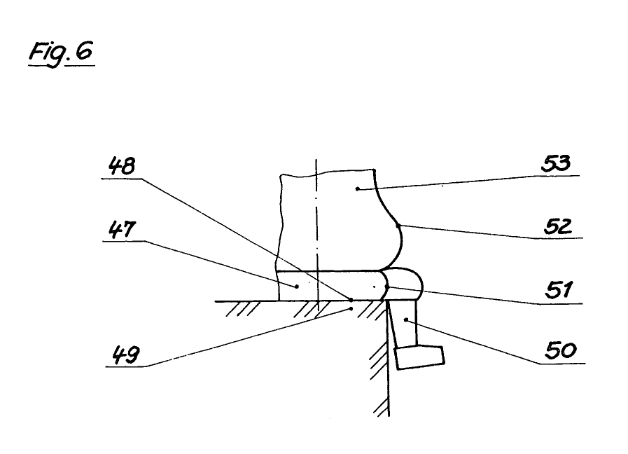

This invention is described in greater below on the basis of six exemplary embodiments illustrated in FIGS. 1 through 5, where the embodiments illustrated here depict preferred forms only at the time of the filing of the present patent application. To this extent they are not definitive for the scope of this invention.

Exemplary Embodiment 1

This exemplary embodiment illustrated in FIG. 1 shows the basic design of the inventive decorative article.

A safety plate 2 is arranged approximately at the center of base 1 as usual and a cone of incense 3 is placed on the plate. A structural part 4 which is arranged concentrically above the base 1 is hollow on the inside, forming a burning chamber 5. The outside contour 6 of the structural part 4 is preferably but not necessarily designed to simulate natural models.

At the upper 7 of the structural part 4 there is a borehole 8 which accommodates a graduated sleeve 9. A borehole 10 is arranged concentrically in the graduated sleeve 9, forming a first section of a smoke gas channel.

The borehole 8 and the graduated sleeve 9 are arranged in the structural part 4 so that they form an angular position which deviates from the vertical. At the upper end 11 of the graduated sleeve 9 another structural part 12 attached; this may be the simulation of a head, for example. A borehole 13 that is created in the structural part 12 has a path different from that of the borehole 8 in the graduated sleeve 9.

The borehole 13 forms a second section of the smoke gas channel. At the end 14 of the borehole 13 boreholes 15 and 16 are created peripherally, each ending in outlet openings 17 and 18. These boreholes form a third section of the smoke gas channel.

On the outside, additional structural parts, including arms 19 and 20, collars 21 and the like, may be provided on the structural part 4 forming the body to supplement the decorative article. In addition, as shown in FIG. 1, various arm positions may be implemented, and it is likewise possible to provide an additional accessory.

The shape of the structural part 12 which forms the head may also simulate a natural model and in particular, it may essentially also determine the character of the decorative article when supplemented with extras present in the structural part 4. FIG. 1 depicts an embodiment which is a model simulation of a hippopotamus.

Furthermore, for design considerations, the decorative article may also be supplemented with a placement plate 22 and with legs 23 and 24.

Exemplary Embodiment 2

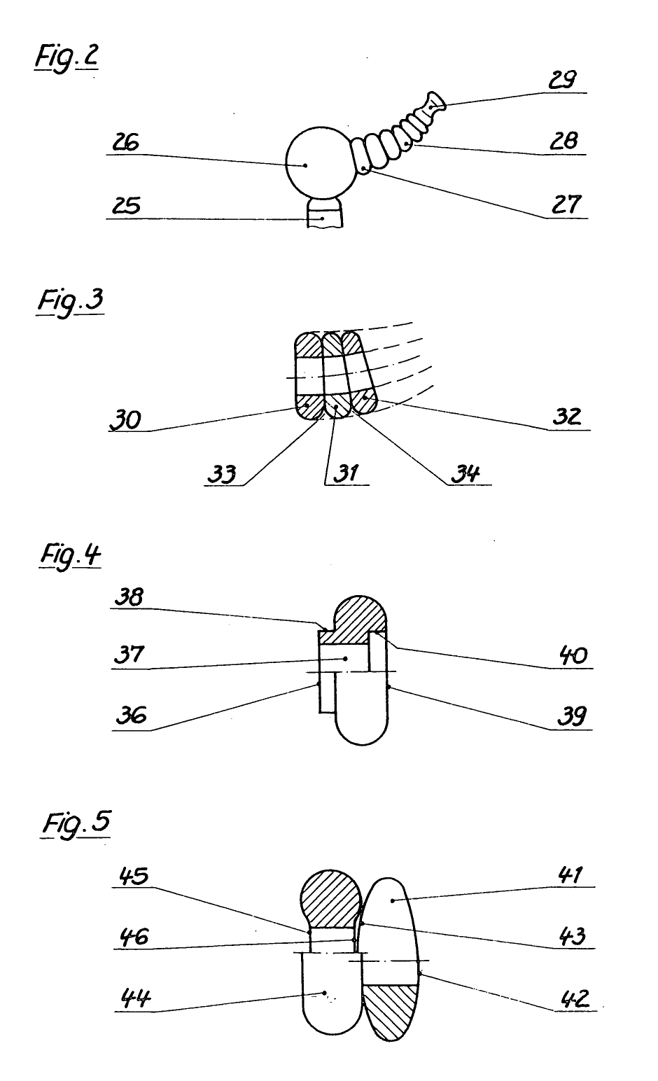

In this exemplary embodiment which is shown in FIG. 2, a different embodiment of the second section of the smoke gas channel is described. The burning chamber and the first section of the smoke gas channel may be designed as described in the preceding exemplary embodiment.

The sleeve-like structural part 25 sits in another structural part 26, which connects the first section of a smoke gas channel to the second section of same. The second section of the smoke gas channel is composed of a plurality of structural parts 27, 28 and 29.

Structural part 27 is essentially a ring having parallel end faces. Structural part 28 is also a ring shape, with the end faces of the ring not being situated in parallel with one another. Structural part 29 is also ring-shaped, but it has profiling of the outside contour which is implemented according to design considerations. The end faces of the structural parts 27, 28 and 29 may be at any desired angle to the axis of the smoke gas channel.

Through a targeted combination of structural parts 27, 28 and 29, it is possible to achieve a curvature of the smoke gas channel whereby depending on the number and type of structural parts used, a simple multiple curvature or a wavy pattern can be achieved.

The structural parts 27, 28 and 29 are preferably glued together at their end faces.

The second sections of a smoke gas channel designed in this way make it possible to model, for example, the shape of an elephant's trunk or the body of a snake. The outside contour of the structural parts 27, 28 and 29 which remains visible may be additionally profiled, depending on design requirements.

Exemplary Embodiment 3

In this exemplary embodiment, a preferred embodiment of the second section of the smoke gas channel according to exemplary embodiment 2 is described.

A ring-shaped structural part 30 is connected to another ring-shaped structural part 31 and optionally to a ring-shaped structural part 32. The structural part 31 has end faces 33 and 34 that are not parallel to one another, so that this arrangement of the structural parts 30 and 32 results in a change in angle. The boreholes, which are created to be concentric, thus form a continuous borehole with kinks.

Structural part 31 is preferably created from one structural part 30 or 32 by grinding and polishing one or both of the end faces. This makes it possible to achieve the result that the number of structural parts to be machined is minimized.

Preferably the structural part 30 has a larger diameter and/or thickness than structural part 31. This makes it possible to achieve the required variation in the outside diameter of this section of the smoke gas channel.

Exemplary Embodiment 4

In this exemplary embodiment, an embodiment of the concentric rings which permits a better connection with a greater thermal stability is described.

A ring-shaped structural part 35 has a collar 38 which is integrally molded on its end face 36 and is concentric with the borehole 37. A depression 40 is created on the opposite side 39, corresponding at least to the dimensions of the collar 38.

The ring-shaped structural part may be paired with a similarly constructed ring-shaped structural part or with structural parts without a collar or depression.

One particular advantage of the ring-shaped structural parts designed in this way is that a greater contact surface with adjacent structural parts is achieved and the thermally stressed structural parts can be glued together more reliably.

According to the embodiments described above, ring-shaped structural parts can also be designed with two integrally molded collars or two depressions each.

Exemplary Embodiment 5

In this exemplary embodiment, a form of the second section of the smoke gas channel is described which makes such a channel according to exemplary embodiment 2 especially simple to manufacture.

According to this invention, ring-shaped structural parts 41 with convex end faces 42 and 43 are each paired with ring-shaped structural parts 44 having concave end faces 45 and 46. The outside diameter and the profiling of the outside shape can be selected at will.

According to the shape of the smoke gas channel to be implemented, a model for the borehole for the smoke gas channel may be prepared and this model may also serve as a guide for its construction. By assembling in a predetermined order and at the same time gluing the ring-shaped structural parts 41 and/or 44 together, the second section of the smoke gas channel can be manufactured effectively.

This embodiment of the smoke gas channel allows the end faces of the ring-shaped structural parts to be structural partially visible. With an appropriate design of the overall shape of the modular unit to be created, however, this is acceptable.

An especially advantageous form of the smoke gas channel designed in this way is obtained when instead of the model auxiliary mold, a guide structural part that is sufficiently stable and forms a lining in the borehole of the smoke gas channel is used and remains in the smoke gas channel.

Exemplary Embodiment 6

In this exemplary embodiment, a form of the inventive decorative article which allows a different type of placement in comparison with the design forms known in the past is explained in greater detail.

A decorative article such as that described in the preceding exemplary embodiments, is designed so that the placement plate 47 stands with its bottom side 48 on a substrate 49.

If the decorative article has extremities 50 or other additional structural parts, they are arranged on the circumference 51 of the placement plate 47 or on the circumference 52 of the structural part 53.

The inventive decorative articles are designed so that they have a center of gravity axis which makes it possible to place it securely on the substrate 49. If additional structural parts are arranged, they may displace the center of gravity position somewhat from the central position, but they will not significantly reduce the stability of the decorative article. This makes is possible to create first sitting figurines without requiring extra structural parts and second to select an embodiment in which the additional structural parts intersect the base area at the bottom and thus make it possible to arrange the figurines on any housing edge, a board or the like.

1. A smoke-emitting decorative article in which a placement surface supports a cone of incense, the placement surface in combination with a surrounding structural part (housing) forming a hollow space (burning chamber), a first section of a smoke gas channel arranged approximately in the area of the upper end of the hollow space so that it rises steeply but not vertically, a second section of a smoke gas channel being arranged with a small slope at the end of the first section, and the smoke gases which are formed in combustion of the incense cone situated in the hollow space being released through the smoke gas channel.

2. The smoke-emitting decorative article according to claim 1, characterized in that the first section of the smoke gas channel forms a long straight borehole.

3. The smoke-emitting decorative article according to one of claims 1 or 2, characterized in that the first and/or second section of the smoke gas channel run(s) with a slope that changes once or more in at least a portion of its length.

4. The smoke-emitting decorative article according to one of claims 1 or 2, characterized in that the first and/or second section of the smoke gas channel run(s) at least structural partially outside of the structural part (housing) and is/are formed by additional structural parts that are provided.

5. The smoke-emitting decorative article according to claim 4, characterized in that the second section of the smoke gas channel consists of a plurality of interconnected individual structural parts.

6. The smoke-emitting decorative article according to claim 5, characterized in that the individual structural parts are of different lengths and/or diameters and/or have end faces that are not plane parallel.

7. The smoke-emitting decorative article according to claim 5, characterized in that the individual structural parts have positive and/or negative profiling and/or coaxial collars and/or receiving boreholes on their end faces for connecting and/or centering opposing structural parts.

8. The smoke-emitting decorative article according to claim 1, characterized in that at least a third section of the smoke gas channel is situated at the end of the second section of the smoke gas channel.

9. The smoke-emitting decorative article according to claim 8, characterized in that two third sections of the smoke gas channel which are arranged so they are approximately symmetrical with the central axis of the decorative article form outlet openings.

10. The smoke-emitting decorative article according to one of the preceding claims, characterized in that said article is to be obtained by a combination of a placement plate (base) with a housing, forming a burning chamber for an incense cone, and this is supplemented with structural parts which form a first and second and/or third section of the smoke gas channel and lining these sections, whereby the structural parts are supplemented by outside contours designed according to aesthetic considerations and/or by model simulations designed according to models present in the real world.

11. The smoke-emitting decorative article according to claim 10, characterized in that said article is to be obtained by combination with additional structural parts for extremities and/or head and/or base in a design like a figure and/or model.

12. The smoke-emitting decorative article according to claim 10, characterized in that the additional structural parts which form extremities or the like are arranged on the circumference of the placement plate and/or on the circumference of the structural part (housing) and the placement plate at the same time serves as the base plate of the decorative article.
